(19) United States
(12) Patent Application Publication
(10) Pub. No.: US 2026/0282189 A1
(43) Pub. Date: Sep. 17, 2026

(54) SMART LIGHT EMITTING DIODE SYSTEM

(71) Applicant: SEEOYON E-HWA CO., LTD., Anyang (KR)

(72) Inventor: Jonghwan JEON, Anyang (KR)

(21) Appl. No.: 19/463,675

(22) Filed: Jan. 29, 2026

(30) Foreign Application Priority Data
Mar. 17, 2025 (KR) 10-2025-0033785

(51) Int. Cl. H05B 45/36; H05B 45/375; H05B 47/155; H05B 47/175

(52) U.S. Cl. CPC H05B 45/36; H05B 45/375; H05B 47/155; H05B 47/198

(57) ABSTRACT

The present invention relates to a smart LED system. According to one aspect of the disclosed invention, the smart LED system includes at least one lighting group including at least one smart lighting device, a controller configured to output a control command signal for controlling an operation of the lighting group, a communication Interface provided between the lighting group and the controller and configured to transmit and receive signals between the lighting group and the controller, and a power Interface connected to at least one of the lighting group, the controller, and the communication Interface and configured to supply power from a power supply. The communication Interface may include a transceiver provided between the lighting group and the controller, a first filter element provided between the transceiver and the controller to remove noise, and a second filter element provided between the transceiver and the lighting group to remove noise.

### CROSS-REFERENCE TO RELATED APPLICATION

This application claims the benefit of Korean Patent Application No. 10- 2025-0033785, filed on March 17, 2025 in the Korean Intellectual Property Office, the disclosure of which is incorporated herein by reference.

### TECHNICAL FIELD

Embodiments of the present disclosure relate to a smart LED system.

### BACKGROUND

Various control schemes using conventional mood lamps have continuously been proposed, such as reducing driver fatigue or providing warnings to a driver in emergency situations by using vehicle interior mood lamps.

Meanwhile, mood lamps have evolved beyond simply using LEDs (Light Emitting Diodes), and smart LEDs are being applied to mood lamps. A smart LED refers to a device in which a control circuit and a memory for driving the LED are embedded within an LED chip. In controlling such smart LEDs, there exists a distance limitation in order to satisfy the reliability requirements of electromagnetic compatibility (EMC) testing.

FIG. 1 is a schematically illustrates a basic configuration of a conventional smart LED system in which a communication line length between smart LEDs exceeds 30 cm, FIGS. 2 is a schematically illustrates a basic configuration of a conventional smart LED system in which a communication line length between smart LEDs is within 30 cm and FIGS. 3 is a schematic illustrates a circuit configuration of a conventional smart LED system in which a communication line length between smart LEDs is within 30 cm.

Referring to FIG. 1, the conventional smart LED system may include a controller (10) and at least one lighting group (G1, G2, G3) connected thereto. Referring to lighting group G1 of FIG. 1, a transceiver (31-1) for LED communication is disposed between the controller (10) and a smart LED 21-1, and transceivers (31-2, …, 31-n) are respectively disposed between connected smart LEDs. This configuration is adopted because, in order to satisfy the reliability requirements of electromagnetic compatibility testing, the communication line length between smart LEDs is limited to within 30 cm. Accordingly, when the communication line length between smart LEDs exceeds 30 cm, additional transceivers are required.

Referring to FIG. 2, when the communication line length between smart LEDs is within 30 cm, multiple lighting groups (G4, G5, G6) include only one transceiver between each lighting group and the controller (10). Referring to FIG. 3, when transceivers (34, 35) connecting the lighting groups (G4, G5) and the controller (10) are respectively provided for each lighting group (G4, G5), the distance d1 between each smart LED included in each lighting group (G4, G5) must be within 30 cm in accordance with regulations for satisfying electromagnetic compatibility reliability.

Accordingly, in conventional smart LED systems, installation is restricted due to the length limitation between smart LEDs, and when transceivers are added according to the spacing between smart LEDs in order to overcome this limitation, there has been a problem of increased manufacturing cost.

### SUMMARY

In view of the above, an aspect of the disclosed invention aims to provide a smart LED system capable of reducing manufacturing cost by minimizing the number of transceivers while satisfying the reliability requirements of electromagnetic compatibility testing, without being constrained by the length limitation of wires connecting smart LEDs.

According to one aspect of the disclosed invention, a smart LED system includes: at least one lighting group including at least one smart lighting device; a controller configured to output a control command signal for controlling an operation of the lighting group; a communication Interface provided between the lighting group and the controller and configured to transmit and receive signals between the lighting group and the controller; and a power Interface connected to at least one of the lighting group, the controller, and the communication Interface and configured to supply power from a power supply.

The communication Interface may include: a transceiver provided between the lighting group and the controller; a first filter element provided between the transceiver and the controller to remove noise; and a second filter element provided between the transceiver and the lighting group to remove noise.

According to one aspect of the disclosed invention, the lighting group may include a third filter element provided between a first smart lighting device, which is connected closest to the communication Interface via a communication line, and the second filter element, to remove noise.

According to one aspect of the disclosed invention, at least one of the first filter element, the second filter element, and the third filter element may be a common mode choke.

According to one aspect of the disclosed invention, the power Interface may include a voltage regulator provided between the power supply and the lighting group, and a first diode element provided between the voltage regulator and the lighting group.

According to one aspect of the disclosed invention, the lighting group may include a second diode element provided between a first smart lighting device, which is connected closest to the power Interface via a power line, and the first diode element.

According to one aspect of the disclosed invention, at least one of the first diode element and the second diode element may be a TVS (Transient Voltage Suppressor) diode.

According to one aspect of the disclosed invention, the power Interface may include a power line connecting the voltage regulator and the transceiver.

According to one aspect of the disclosed invention, when the lighting group includes a plurality of smart lighting devices, the plurality of smart lighting devices may be connected in series through a power line connected to the power Interface and a communication line connected to the communication Interface.

According to one aspect of the disclosed invention, when a plurality of lighting groups is provided, the smart LED system may further include a connection line connecting the communication Interface connected to the controller and another communication Interface provided in another lighting group, and the connection line may include at least one fourth filter element provided on a communication line connecting the transceiver and the transceiver of the other communication Interface to remove noise.

According to one aspect of the disclosed invention, the fourth filter element may be a common mode choke.

According to one aspect of the disclosed invention, it is possible to satisfy the reliability requirements of electromagnetic compatibility testing between smart LEDs while reducing manufacturing cost by requiring only one transceiver per lighting group, instead of requiring as many transceivers as the number of smart LEDs included in a single lighting group.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a schematically illustrates a basic configuration of a conventional smart LED system in which a communication line length between smart LEDs exceeds 30 cm;

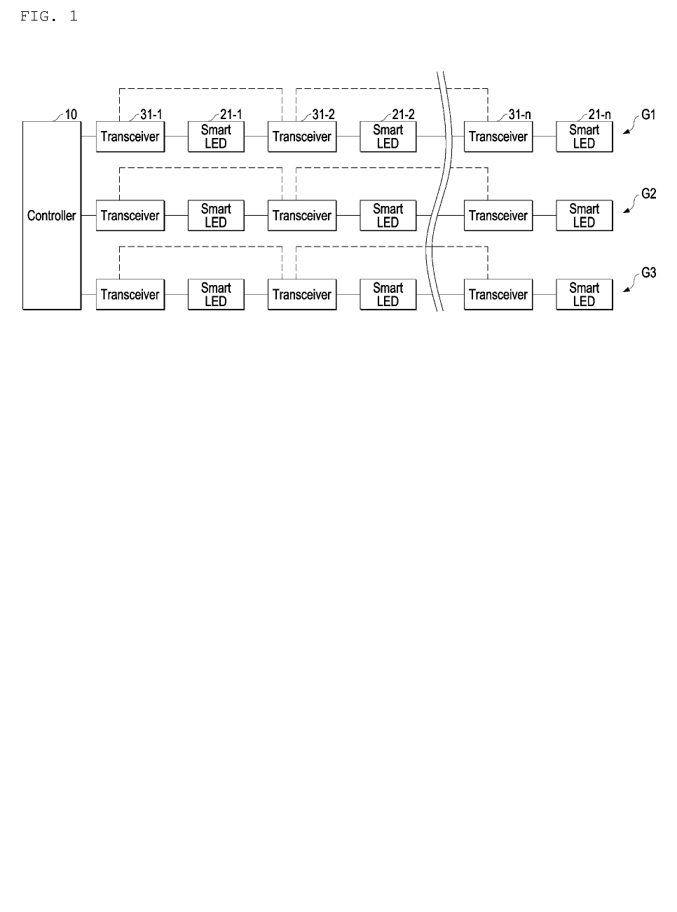

FIGS. 2 is a schematically illustrates a basic configuration of a conventional smart LED system in which a communication line length between smart LEDs is within 30 cm;

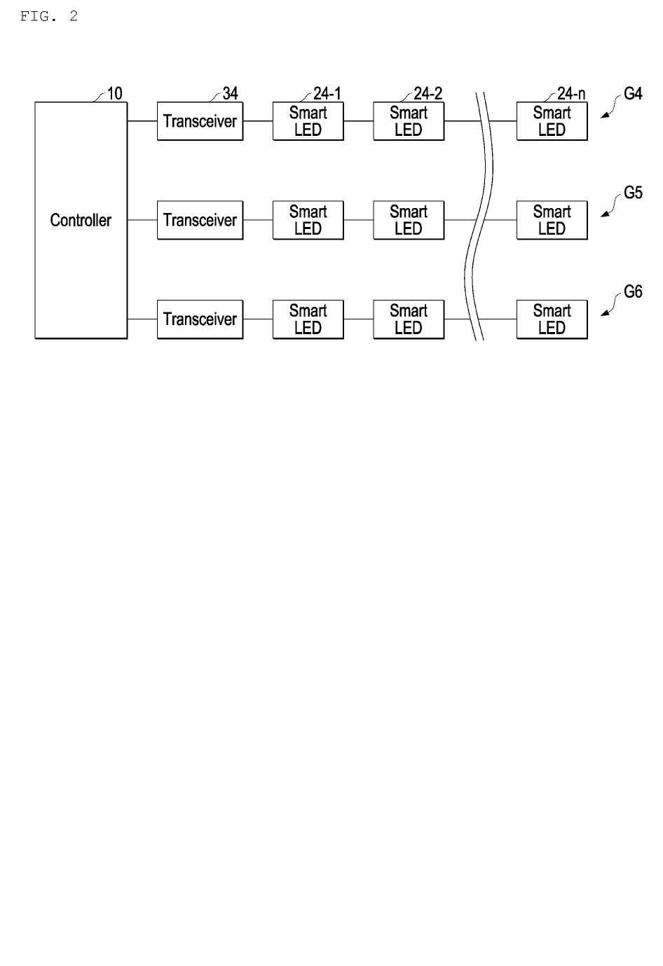

FIGS. 3 is a schematic illustrates a circuit configuration of a conventional smart LED system in which a communication line length between smart LEDs is within 30 cm;

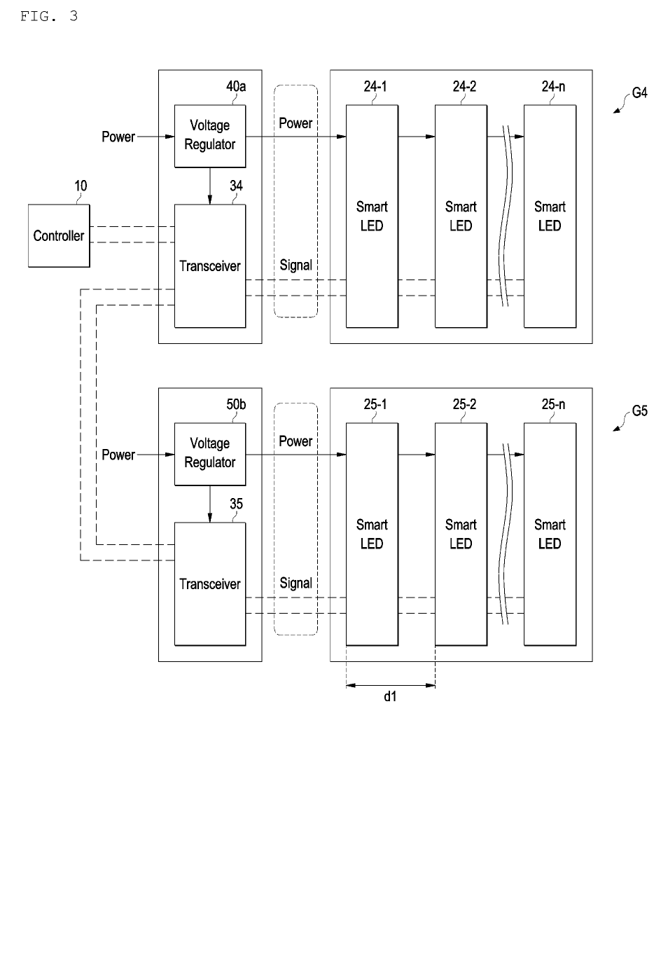

FIG. 4 is a schematically illustrates a basic configuration of a smart LED system according to one embodiment of the present invention; and

FIG. 5 is a schematically illustrates a circuit configuration of a smart LED system including a plurality of lighting groups according to one embodiment of the present invention.

### DETAILED DESCRIPTION

Throughout the specification, the same reference numerals refer to the same components. This specification does not describe all elements of the embodiments, and descriptions of matters generally known in the art to which the disclosed invention pertains or overlapping descriptions among the embodiments are omitted. The terms “unit,” “Interface,” “member,” and “block” used in this specification may be implemented in software or hardware, and according to embodiments, a plurality of “units,” “Interfaces,” “members,” or “blocks” may be implemented as a single component, or a single “unit,” “Interface,” “member,” or “block” may include a plurality of components.

Throughout the specification, when a component is described as being “connected” to another component, this includes not only a direct connection but also an indirect connection, and the indirect connection includes a connection through a wireless communication network.

In addition, when a component is described as “including” another component, this does not exclude other components unless explicitly stated otherwise, and may include additional components.

Throughout the specification, when a component is described as being positioned “on” another component, this includes not only a case in which the component is in direct contact with the other component but also a case in which another component exists between the two components.

Terms such as “first” and “second” are used to distinguish one component from another, and the components are not limited by these terms.

The singular expressions include plural expressions unless the context clearly indicates otherwise.

Reference numerals used for steps are provided for convenience of description and do not indicate an order of the steps, and the steps may be performed in an order different from the order described unless a specific order is clearly stated in the context.

Hereinafter, the operating principles and embodiments of the disclosed invention will be described with reference to the accompanying drawings.

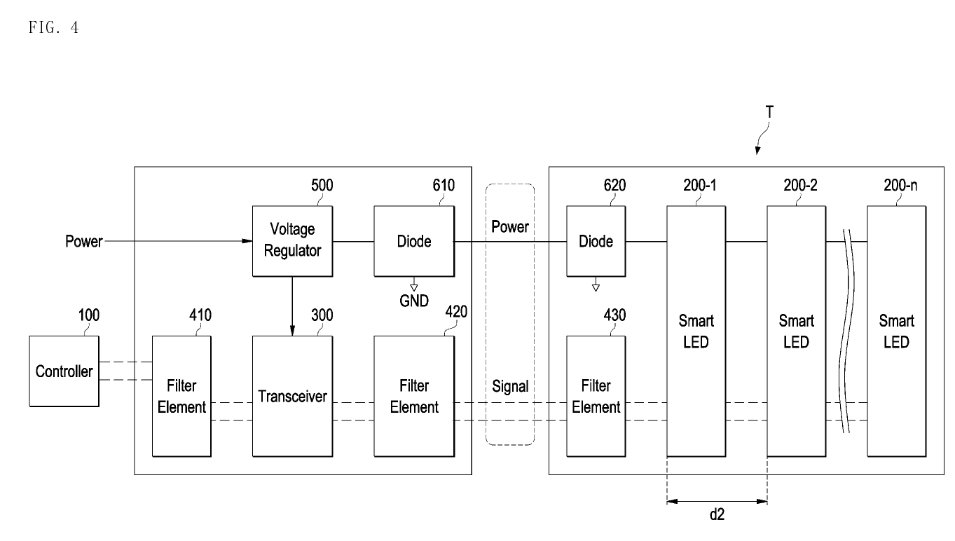

FIG. 4 is a schematically illustrates a basic configuration of a smart LED system according to one embodiment of the present invention.

As shown in FIG. 4, the smart LED system of the present invention may include a controller (100), at least one lighting group (T), a communication Interface, and a power Interface.

Although not illustrated, the controller (100) may include a memory and a processor for controlling overall operations of the controller (100). The memory may store various programs and data required for the operation of the controller (100). The processor may control the overall operation of the controller (100) by using the programs stored in the memory.

The lighting group (T) may include at least one smart lighting device (hereinafter referred to as a “smart LED (Light Emitting Diode)”) (200-1, 200-2, …, 200-n).

The smart LED may be a lighting device in which a control circuit and a memory for driving the LED are embedded within an LED chip.

The controller (100) may provide, through the communication Interface, a control command signal for controlling operations of the smart LEDs included in the lighting group (T). In addition, the controller (100) may monitor operating states of the smart LEDs included in the lighting group (T) through the communication Interface.

The communication Interface is provided between the lighting group (T) and the controller (100) and may transmit and receive signals between the lighting group and the controller. Referring to FIG. 4, the communication interface as described herein comprises physical circuitry may include a transceiver (300) and a plurality of filter elements (410, 420).

As an embodiment, the transceiver (300) may be a transceiver capable of transmitting and receiving control command signals through differential signal lines, and it may be replaced with various devices for signal transmission and reception. The transceiver (300) may be provided between the lighting group (T) and the controller (100).

In addition, although not illustrated, the controller (100) may further include a separate transceiver.

Referring to FIG. 4, the communication Interface may include a first filter element (410) provided between the transceiver and the controller (100) to remove noise, and a second filter element (420) provided between the transceiver and the lighting group (T) to remove noise. As an embodiment, at least one of the first filter element (410), the second filter element (420), and a third filter element (430) described below may be a common mode choke, and may of course be replaced with various devices for noise removal.

Meanwhile, the lighting group (T) may include a third filter element (430) provided between a first smart LED (200-1), which is connected closest to the communication Interface through a communication line, and the second filter element (420), to remove noise.

The power Interface may be connected to at least one of the lighting group (T), the controller (100), and the communication Interface, and may supply power from a power supply to the lighting group (T), the controller (100), and the communication Interface. The power supply may be a battery, a capacitor, a vehicle power source, or various other power generating devices and/or power storage devices.

Referring to FIG. 4, the power Interface may include a voltage regulator (500) provided between the power supply and the lighting group (T), and a first diode element (610) provided between the voltage regulator (500) and the lighting group (T). The voltage regulator (500) may step down a voltage of 12 V to 5 V through a voltage drop.

The lighting group (T) may include a second diode element (620) provided between a first smart LED (200-1), which is connected closest to the power Interface through a power line, and the first diode element (610).

At least one of the first diode element (610) and the second diode element (620) may be a TVS (Transient Voltage Suppressor) diode.

By supplying power to the lighting group (T) through the plurality of diode elements (610, 620), the power Interface may improve voltage stability. For example, the power Interface may prevent voltage variation caused by conductor resistance due to the length of the power line and contact resistance of wire connectors and PCB connectors constituting the power line, by means of the plurality of diode elements (610, 620).

Meanwhile, referring to FIG. 4, the power Interface may include a power line connecting the voltage regulator (500) and the transceiver (300) in order to supply power to the communication Interface.

As shown in FIG. 4, the lighting group (T) may include one or more smart LEDs (200-1, 200-2, …, 200-n). The lighting group (T) may be configured such that the plurality of smart LEDs (200-1, 200-2, …, 200-n) are connected in series through a power line connected to the power Interface and a communication line connected to the communication Interface.

The smart LED system of the present invention requires only one transceiver (300) per lighting group, and by configuring the plurality of filter elements (410, 420, 430) and the plurality of diode elements (610, 620), signal transmission and reception can be performed while ensuring the reliability of electromagnetic compatibility testing even when a distance (d2) between adjacent smart LEDs among the serially connected plurality of smart LEDs exceeds 1 meter.

With this configuration, since signal transmission and reception between smart LEDs can be performed while ensuring the reliability of electromagnetic compatibility testing regardless of the length of the communication line, it is possible to reduce the manufacturing cost of the smart LED system. For example, in conventional smart LED systems, a number of transceivers corresponding to the number of smart LEDs included in each lighting group is required, and thus the cost of transceivers increases in proportion to the number of smart LEDs. In contrast, in the smart LED system of the present invention, only one transceiver is required per lighting group, so the cost of transceivers may be calculated in proportion to the number of lighting groups.

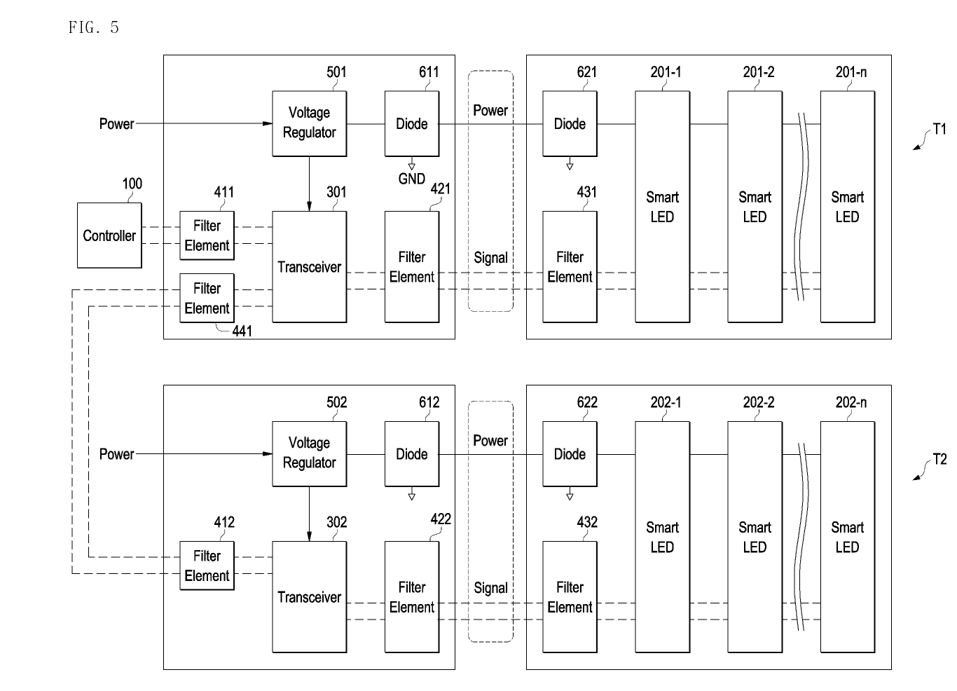

FIG. 5 is a schematically illustrates a circuit configuration of a smart LED system including a plurality of lighting groups according to one embodiment of the present invention.

Referring to FIG. 5, the smart LED system of the present invention may include a plurality of lighting groups (T1, T2).

When the smart LED system of the present invention includes a plurality of lighting groups (T1, T2), the system may further include a connection line connecting a transceiver (301), which is connected to the controller (100) through a first filter element (411), and another transceiver (302) provided in another lighting group (T2). The connection line may be a communication line.

The connection line may include a fourth filter element (441). The fourth filter element (441) may be provided between the two transceivers (301, 302) to control noise. Specifically, referring to FIG. 5, the connection line may be a communication line connecting the fourth filter element (441) corresponding to a first lighting group (T1) that is connected closest to the controller (100) and a first filter element (412) corresponding to a second lighting group (T2) that is connected closest to the first lighting group (T1). As an embodiment, the fourth filter element may be a common mode choke, and may of course be replaced with various devices for noise removal.

As an embodiment, when the smart LED system of the present invention includes a third lighting group including a transceiver connected to the transceiver (301) corresponding to the second lighting group (T2) through a separate connection line, a fourth filter element may be provided in the communication Interface corresponding to the second lighting group (T2).

As an embodiment, the connection line may directly connect the plurality of lighting groups (T1, T2) to the controller (100) through communication Interfaces respectively corresponding to the plurality of lighting groups (T1, T2). In this case, each of the lighting groups (T1, T2) may not include the fourth filter element.

The above description is merely illustrative of the technical spirit of the present invention, and various modifications and variations may be made by those skilled in the art without departing from the essential characteristics of the present invention. Therefore, the embodiments disclosed herein are not intended to limit the technical spirit of the present invention but to describe it, and the scope of the technical spirit of the present invention is not limited by these embodiments. The scope of protection of the present invention should be interpreted according to the appended claims, and all technical ideas within the scope equivalent thereto should be construed as being included in the scope of the present invention.

What is claimed is:

1. A smart LED system comprising:
at least one lighting group including at least one smart lighting device;
a controller configured to output a control command signal for controlling an operation of the lighting group;
a communication Interface provided between the lighting group and the controller and configured to transmit and receive signals between the lighting group and the controller; and
a power Interface connected to at least one of the lighting group, the controller, and the communication Interface and configured to supply power from a power supply,
wherein the communication Interface includes:
a transceiver provided between the lighting group and the controller;
a first filter element provided between the transceiver and the controller to remove noise; and
a second filter element provided between the transceiver and the lighting group to remove noise.

2. The smart LED system of claim 1, wherein the lighting group includes a third filter element provided between a first smart lighting device, which is directly connected to the communication Interface through a communication line, and the second filter element, to remove noise.

3. The smart LED system of claim 2, wherein at least one of the first filter element, the second filter element, and the third filter element is a common mode choke.

4. The smart LED system of claim 1, wherein the power Interface includes:
a voltage regulator provided between the power supply and the lighting group; and
a first diode element provided between the voltage regulator and the lighting group.

5. The smart LED system of claim 4, wherein the lighting group includes a second diode element provided between a first smart lighting device, which is directly connected to the power Interface through a power line, and the first diode element.

6. The smart LED system of claim 5, wherein at least one of the first diode element and the second diode element is a TVS (Transient Voltage Suppressor) diode.

7. The smart LED system of claim 4, wherein the power Interface includes a power line connecting the voltage regulator and the transceiver.

8. The smart LED system of claim 1, wherein, when the lighting group includes a plurality of smart lighting devices, the plurality of smart lighting devices are connected in series through a power line connected to the power Interface and a communication line connected to the communication Interface.

9. The smart LED system of claim 1, wherein, when a plurality of lighting groups is provided, the smart LED system further includes a connection line connecting the communication Interface connected to the controller and another communication Interface provided in another lighting group,
wherein the connection line includes at least one fourth filter element provided on a communication line connecting the transceiver and a transceiver of the other communication Interface to remove noise.

10. The smart LED system of claim 9, wherein the fourth filter element is a common mode choke.
